(19) United States
(12) Patent Application Publication
(10) Pub. No.: US 2009/0108601 A1
(43) Pub. Date: Apr. 30, 2009

(54) Ball engager and retainer and method

(76) Inventor: Reginald Lee, Alameda, CA (US)

Correspondence Address: Law Offices of John W. Carpenter;John W. Carpenter, 12 Metairie Court, Metairie, LA, 70001, US

(21) Appl. No.: 11/977,127

(22) Filed: Oct. 24, 2007

(51) Int. Cl. B65G 1/02; A63B 47/02

(52) U.S. Cl. 294/19.2; 414/332

(57) ABSTRACT

A method for engaging and retrieving golf balls includes aligning the bottom of a tubular member over a golf ball, and pushing down on the tubular member to pass the golf ball through an engaging and receiving assembly. An assembly for engaging and retrieving golf balls comprises a tube member and an engaging the retrieving assembly. The engaging and retrieving assembly comprises a body having a recess. A spring assembly is disposed within the recess, and includes a plurality of spring members.

### FIELD OF THE INVENTION

Embodiments of the present invention are related to an apparatus for engaging round objects, such as balls. More specifically, embodiments of the present invention provide an apparatus and method for engaging and/or retrieving golf balls, such as from the ground, and for retaining the golf ball after being retrieved.

### BACKGROUND OF THE INVENTION

There are a number of conventional golf ball retrievers available to golfers. However, these conventional golf ball retrievers only permit retrieving and retaining golf balls, and do not none combine the features of unique plastic construction, convenient storage and benign spring engagement.

### SUMMARY OF EMBODIMENTS OF THE INVENTION

Embodiments of the present invention provide a method for engaging and retrieving golf balls. The method includes aligning the bottom of a tubular member over a golf ball, and pushing down on the tubular member to pass the golf ball through an engaging and receiving assembly.

Embodiments of the present invention also provide an assembly comprising a tube member and an engager the retrieving assembly. The engager and retrieving assembly comprises a body having a recess. A spring assembly is disposed within the recess, and includes a plurality of spring members.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a side elevational view of golf balls being engaged, retrieved while lying on the ground and retaining the golf balls after being retrieved.

FIG. 2 is a perspective view with respect a top orientation of the engager and retriever assembly.

FIG. 3 is a perspective view with respect a bottom orientation of the engager and retriever assembly.

FIG. 4 is a top plan view of a golf ball disposed in the tube after passing through the engager and retriever assembly.

FIG. 5 is a bottom plan view of a golf ball after passing through the engager and retriever assembly and resting on the spring members and being prevented from falling through the engager and retriever assembly to leave the tube.

FIG. 6 is a partial side elevational view of the embodiment of the invention illustrated in FIG. 5 with the golf ball and spring members being illustrated by dash lines.

FIG. 7 is a top plan view of the spring members.

FIG. 8 is a bottom plan view of the spring members.

FIG. 9 is a perspective view of the spring members.

FIG. 10 is a partial side elevation view of a golf ball in the process of passing in direction of the arrow and through the spring members.

FIG. 11 is a partial side elevation view of a golf ball after passing through the spring members, with the arrow representing the load factor due to any golf balls resting on top of the golf ball.

FIG. 12 is a partial vertical sectional view through the engager and retriever assembly with D representing the horizontal distance between the two pivot points.

FIG. 13 is a horizontal sectional view taken in direction of the arrows and along the plane of line 13-13 in FIG. 12.

FIG. 14 is a partial enlarged top plan view of spring members with R representing an arc length distance (radians) between spring members.

FIG. 15 is a partial side elevation view of a golf ball in the process of passing in direction of the force arrow and through the spring members, with the spring members being flexed (high spring flex) towards the inside of the tube member.

FIG. 16 is a partial side elevation view of a golf ball after passing through the spring members, with the spring members being flexed (low spring flex) away from the inside of the tube and the arrow representing the load factor due to any golf balls resting on top of the golf ball.

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention. It is to be understood that whenever the term “golf ball” is used herein, the term is to mean any ball or round object. Thus, practice of embodiments of the invention are not to be limited to only golf balls, but is to include any ball or round object.

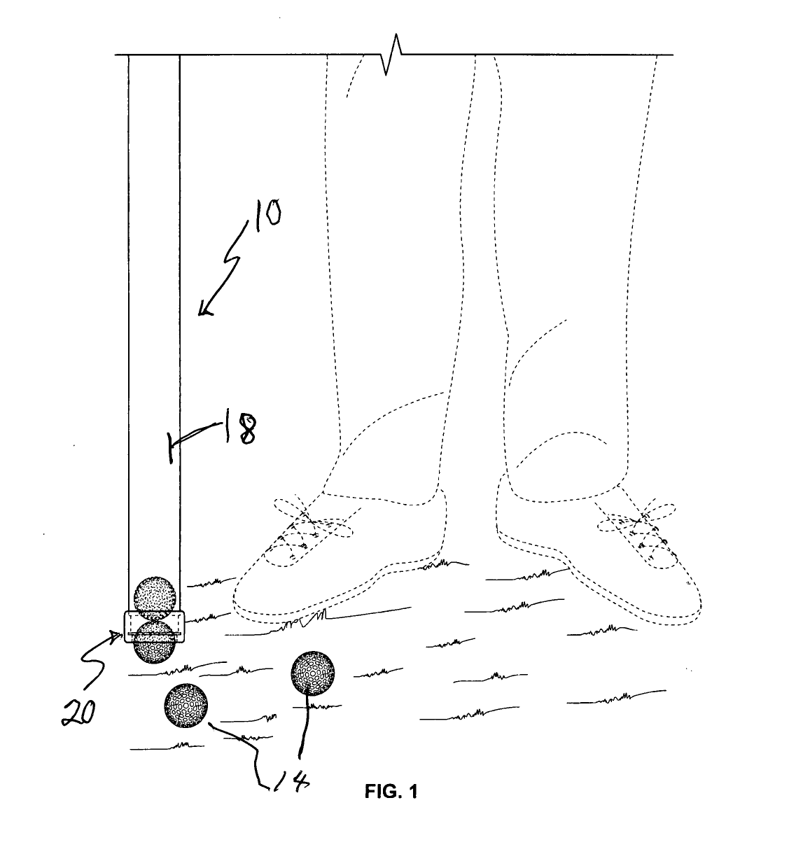

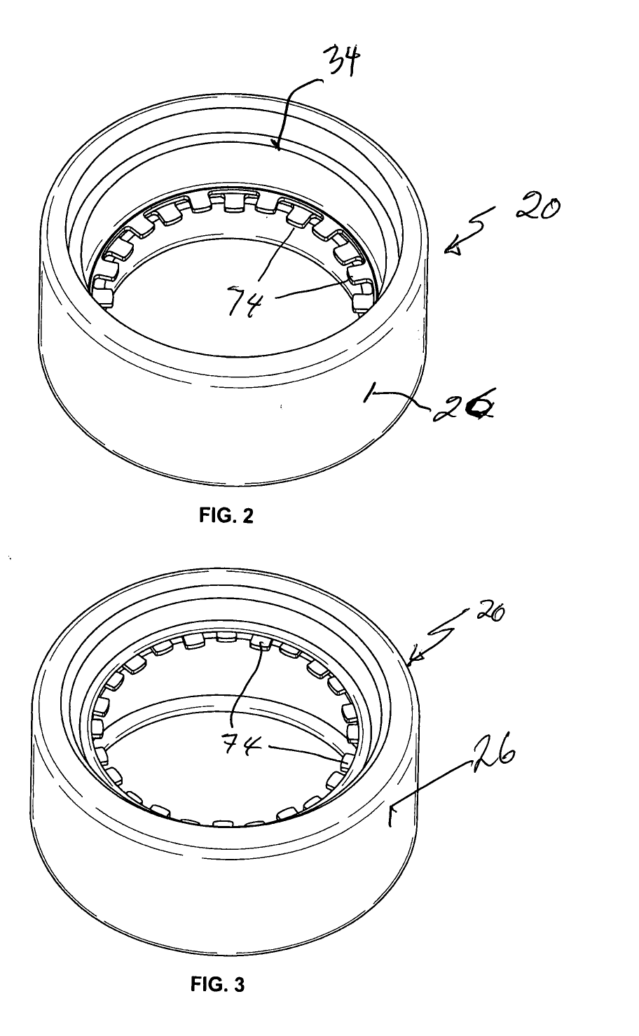

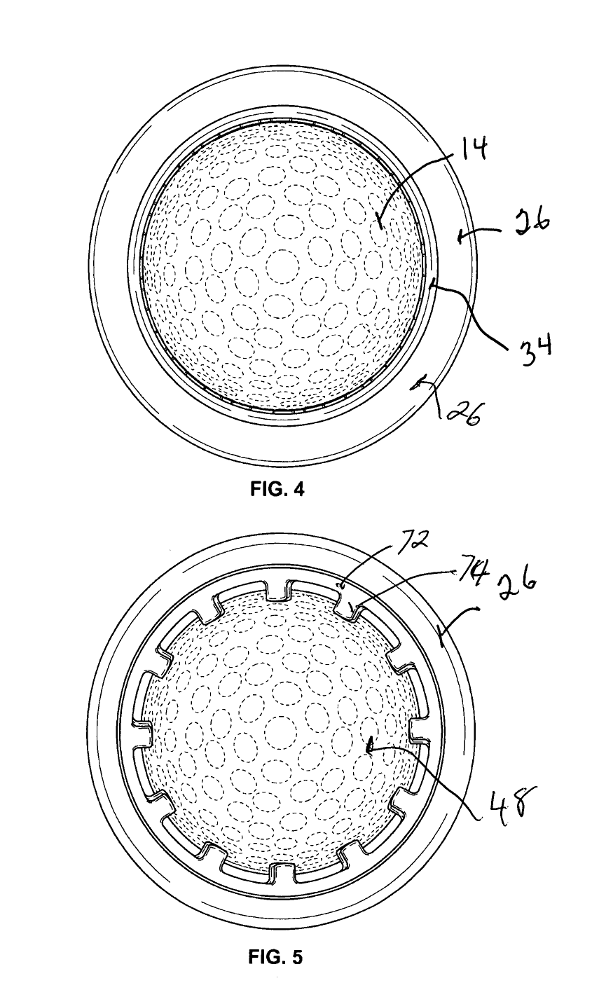

Referring in detail now to the drawings, wherein similar parts of the invention are identified by like reference numerals, there is seen in FIG. 1 a side elevational view of an apparatus, generally illustrated as 10, for engaging, retrieving and retaining golf balls 14, such as while the golf balls 14 are lying on the ground. Apparatus 10 includes a tube member 18 coupled to an engaging and retrieving assembly, generally illustrated as 20. The tube member 18 includes an end 22 (see FIG. 10) which seats on a shoulder (identified as “34” below) of the engager and retrieving assembly 20, which functions as an engager and retriever when the person using the apparatus 10 pushes the tube member 18 downward to force a golf ball 14 against and through a spring assembly (identified as “36” below) whereupon the golf ball 14 is retained while being housed within the tube member 18.

The tube member 18 may be manufactured from any suitable material, preferably a transparent material (e.g., a plastic). The tube member 18 has a length which is dependent of the number of golf balls 14 to be loaded therein. In an embodiment of the invention, the tube member 18 has any suitable length, preferably a length ranging from about 20.00 to about 50.00 inches, more preferably from about 25.00 to about 45.00 inches, most preferably from about 30.00 to about 40.00 inches (e.g., 35.00 to about 36 inches). The internal diameter of the tube member 18 may be any suitable diameter and depends on the circumference of the golf ball (or any ball member) 14 being retained within the tube member 18. For golf balls 14, the internal diameter comprises about 1.75 inches. The outside diameter of the tube member 18 may be any suitable diameter, preferably ranging from about 1.90 to about 2.10 inches (e.g. about 2.00 inches). The thickness of the cylindrical walls of the tube member 18 depends on the value of the internal diameter and the outside diameter.

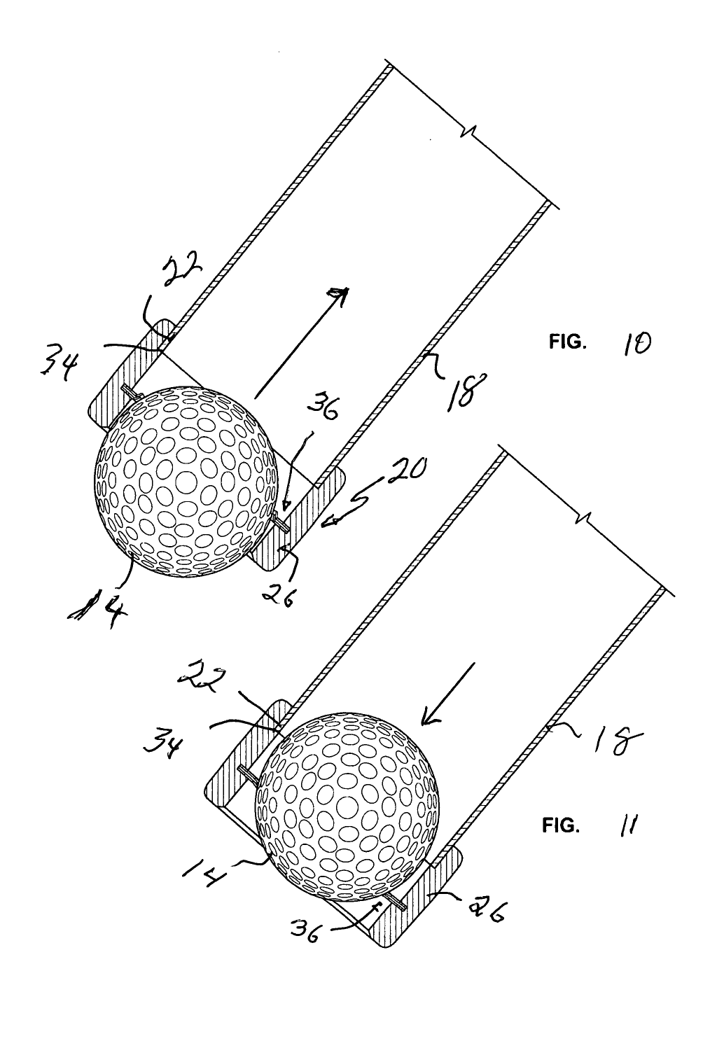

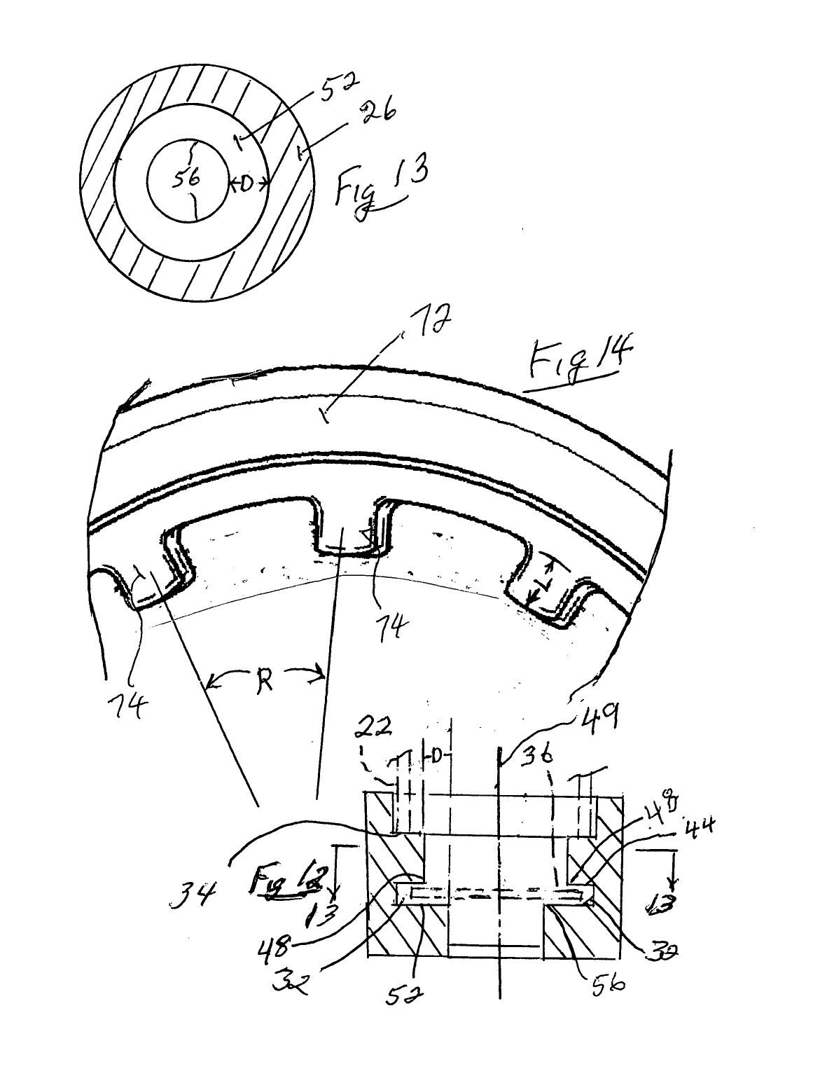

The engager and retrieving assembly 20 includes a generally cylindrical body 26 having an internal shoulder 34 where the end 22 of the tube member 18 seats, as best shown in FIGS. 10 and 11. As best shown in FIGS. 12, 15 and 16, the cylindrical body 26 includes a circumferential recess 32 wherein a spring assembly 36 lodges. Recess 32 is defined by an upper generally planar circumferential surface 44 terminating in upper pivot point 48, and a lower generally planar circumferential surface 52 terminating in lower pivot point 56. The recess 32 also includes a circumferential rear wall 54 bound to circumferential surfaces 52 and 44. The upper circumferential pivot point 48 has a larger diameter than the diameter of the lower circumferential pivot point 56. As best shown in FIGS. 12 and 13, the difference in diameter between the upper circumferential pivot point 48 and lower circumferential pivot point 56 is D. Stated alternatively, D represents the horizontal distance between pivot points 48 and 56. Stated alternatively further and as best shown in FIG. 12, pivot point 48 is located at a greater distance from concentric axis 49 than is pivot point 56.

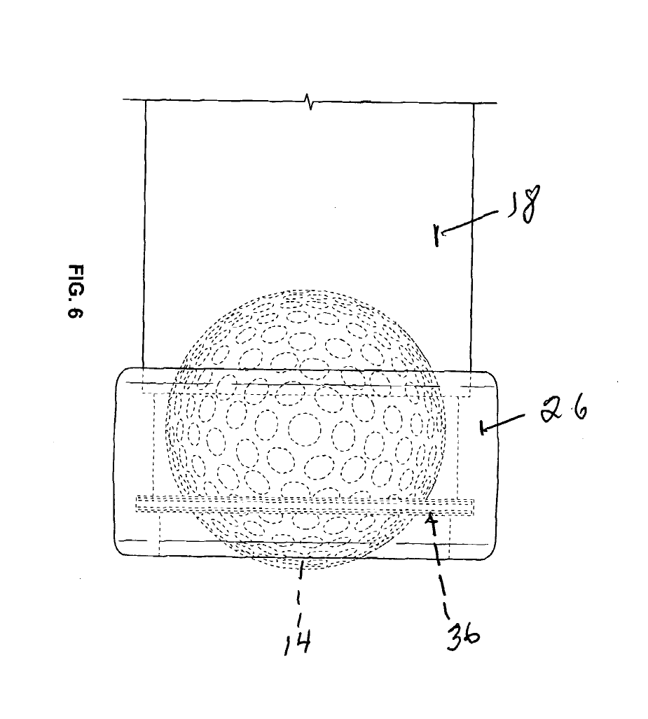

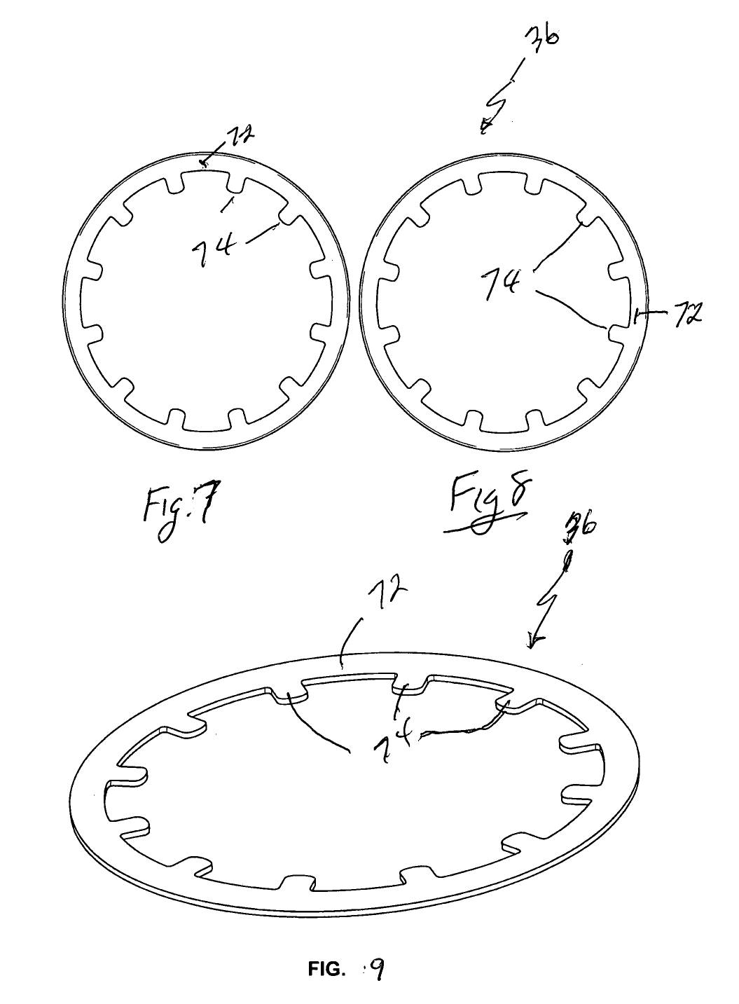

The engager and retrieving assembly 20 also includes a spring assembly, generally illustrated as 36 as best shown in FIGS. 7-9. The spring assembly 36 comprises a ring 72 having integrally bound thereto a plurality of spring members 74.

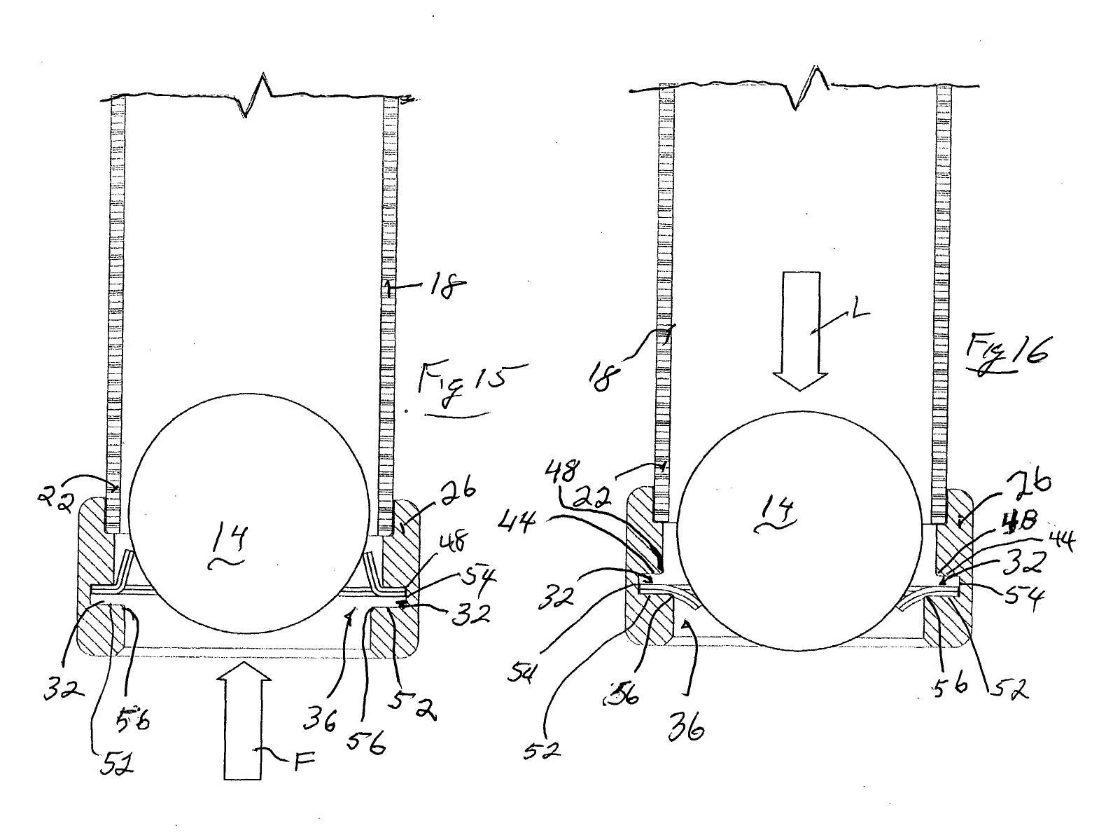

One of the purposes for having the diameter (with respect to the concentric axis of the tube member) of the upper circumferential pivot point 48 greater than the diameter of lower circumferential pivot point 56 is that spring members 74 of the spring assembly 36 flex at the upper circumferential pivot point 48 a distance greater than the distance flexed by the spring members 74 at the lower circumferential pivot point 56. This enables a golf ball 14 to readily pass through the inward protruding spring members 74, as best shown in FIG. 15, while preventing the golf ball 14 to pass back out of the tube member 18, as best shown in FIG. 16. The spring assembly 36 is machined such that when the spring members 74 are pivoting at the lower circumferential pivot point 56, the spring members 74 do not have sufficient flexibility to allow golf balls 14 to pass out of the tube member 18. As further best shown in FIGS. 15 and 16, when a golf ball 14 is entering the tube member 18 through the spring assembly 36 in direction of the arrow F (force), the spring members 74 flex towards the inside to the tube member 18. When one or more golf balls 14 are attempting to leave the tube member 18 through the spring assembly 36 in direction of the arrow L (load), the spring members 74 flex towards the entrance of the tube member 18.

Referring now to FIG. 12, D is illustrated as being that distance from a vertical or normal plane at one specific pivot point (i.e., pivot point 48 in FIGS. 12, 15 and 16) to the other specific pivot point (i.e., pivot point 56 also in FIGS. 12, 15 and 16). The differential in length D between the two specific pivot points 48 and 56 dictates the length of each spring member 74 that is available for pivot. Thus, as illustrated in FIGS. 15 and 16, at pivot point 48, the length of each spring member 74 being pivoted is greater than the length of each spring member 74 being pivoted at point 56. The greater the available length for each spring member 74 to pivot, the greater is the flexibility of each spring member 74 to bend or flex in the direction (direction of arrow F) that the balls 14 are entering the tube member 18. The number of spring members 74 employed may be any suitable number. In a preferred embodiment of the invention, the number of spring members 74 preferably various from 6 to 18, more preferably from 10 to 14, most preferably from 11 to 13 (e.g., 12). As illustrated in FIG. 14, the radial degree R of separation between any two contiguous golf balls 14 depends on the number of spring members 74 being employed. With the preferred number of golf balls 14 being 12, then the radial degree or arc R is 30. In an embodiment of the invention, the radial degree or arc R varies from about 5 to about 40, more preferably from about 10 to about 38 (e.g., about 15); most preferably from about 25 to about 35 (e.g., 30).

In manufacturing the spring assembly 36 including spring members 74, the following parameters (all of which are interdependent on each other) are to be considered: (a) the composition of material from which spring members 74 are manufactured; (b) the differential length D; (c) the thickness, width and length of the spring members 74; (d) the anticipated weight (and number) of the golf balls 14; (e) the radial degree or arc R between each spring element or members; and (f) the average operating temperatures (e.g., ambient operating temperatures) in which the apparatus 10 is to be used.

In an embodiment of the invention, the spring members 74 and the ring 72 are manufactured from a plastic material [e.g. HDPE (high density polyethylene, UHMW (ultra high molecular weight), Nylon®, and Teflon®, or mixtures thereof]. The average operating temperatures depends on weather conditions and typically varies from about 32 to 110 degrees Fahrenheit. The anticipated weight of the golf balls 14 depends on the length of the tube member 18, and may preferably vary from 1.5 lbs to about 4.0 lbs more preferably from about 1.8 lbs to about 3.5 lbs most preferably from about 2.0 lbs to about 3.0 lbs (e.g., from about 2.5 lbs. to about 2.6 lbs).

The difference in length D between the two specific pivot points 48 and 56 may be any suitable length, and depends on a number of factors including the average anticipated weight (and number) of the golf balls 14 in the tube member 18; the greater the number of balls 14 translates into a greater weight against the spring members 74 for resisting and impeding the spring members 74 from flexing in both directions. The length D preferably varies from about 0.01 to about 0.25 inches, more preferably from about 0.03 to about 0.20 inches, most preferably from about 0.06 to about 0.15 inches (e.g., about 0.10 inches).

In an embodiment of the invention, the thickness of each spring finger member 74 may be any suitable thickness, preferably one that varies from about 0.01 to about 0.09 inches, more preferably from about 0.015 to about 0.07 inches, most preferably from about 0.02 to about 0.05 inches (e.g., about 0.0313 inches). The length of each spring member 74, preferably one varying from about 0.04 to about 0.40 inches, more preferably from about 0.06 to about 0.30 inches, most preferably from about 0.1 to about 0.2 inches (e.g., about 0.15 inches). The width of each spring member 74 may be any suitable width, preferably one varying from about 0.005 to about 0.03 inches, more preferably from about 0.006 to about 0.025 inches, most preferably from about 0.008 to about 0.02 inches (e.g., about 0.013 inches).

In the practice of various other embodiments of the invention and as previously suggested, the spring members 74 are designed by using derived beam deflection calculations for cantilever beams based on the 2^{nd}, 3^{rd}, and 4th order differential equations for deflection, as described in Shigley and Miscnke, Mechanical Engineering Design, Fifth Edition, published by McGraw-Hill Book Company 1989, and fully incorporated herein by reference thereto. The maximum load may be defined for a reasonable amount of regulation golf balls 14 to be stored in the tube member 18. As previously suggested, information for a worse case scenario loads or dynamic weight was considered. This weight may be used to evaluate what type of cantilever beam would suffice as a support and detent for a golf ball 14. Understanding those requirements allows one to creatively distribute the load within a certain volume. From there, one is to consider a streamlined form factor for which to distribute the cantilever beams. The variation in the location of the pivot points 48 and 56 define what order deflection that is allowed in the up and down position.

By the practice of various embodiments of the invention, the spring members 74 move (or flex) in one direction (inward) for allowing the golf balls 14 to enter into the tube member 18. The spring members 74 can not move or fully flex in the opposite direction (outbound) due to the design of the circumferential recess 32 where the ring member 72 seats. The dimensions of the circumferential recess 32 in relation to the thickness of the springs members 74 and gravity prevent the spring members 74 from fully flexing, thus locking the golf balls 14 into place. As previously suggested, the thickness, width and length of the spring members 74 are preferably engineered to hold the load of the maximum amount of golf balls 14 in the tube member 18. The freedom of the spring members 74 (including the ring 72) to rotate within the circumferential recess 32 not only induces a smooth transition of the balls 14 into the tube member 18, but also allows for uniform contact and random wear points.

In the practice further embodiment of the invention and as further previously suggested, the material property of the spring members 74 and their thickness are to be considered in that the material of the spring members 74 preferably recoil that functions appropriately for the given load. A failure analysis is preferably conducted for a successful and reliable cycling of the spring members 74 without failure. An isochronous chart (stress vs. strain) is employed for selecting the material (e.g., plastic) of the spring members 74, as described by Shigley and Mischke, Mechanical Engineering Design, Fifth Edition, published by McGraw-Hill Book Company 1989 or at http://prospector,ides.com/MPChart.aspx?E=18996&P=10180&E18996=ALL, and fully incorporated herein by reference thereto. The isochronous chart, as described in the foregoing references, is preferably employed for various plastics considering abrasion (sand), temperature differential (hot to cold), and UV light (from the sun) and selected HDPE (high density polyethylene). From that chart a successful or acceptable failure may be interpolated with a factor of safety of two (12×2=24 springs).

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. An apparatus for retrieving and retaining one or more balls comprising:
a tube member having an end; and an engaging and retrieving assembly including
a cylindrical body having a structure defining an internal shoulder wherein said end of said tube member seats, and a circumferential recess having a first circumferential surface terminating in a first circumferential pivot point and a second circumferential surface terminating in a second circumferential pivot point, said first circumferential pivot point is located at a greater distance from a concentric axis than is said second circumferential pivot point; and a spring assembly disposed in said circumferential recess for allowing one or more balls to pass there through in a direction toward the inside of said tube member while preventing said one or more balls to pass out of said tube in a direction opposite the direction where said one or more balls travel for disposal inside the tube.

2. The apparatus of claim 1 wherein said spring assembly comprises a ring and a plurality of inward protruding spring members coupled thereto.

3. The apparatus of claim 2 wherein said spring members flex in one direction farther than in the opposite direction.

4. The apparatus of claim 3 wherein the difference in diameter between the first circumferential pivot point and second circumferential pivot point ranges from about 0.01 inches to about 0.25 inches.

5. The apparatus of claim 3 wherein the difference in diameter between the first circumferential pivot point and second circumferential pivot point ranges from about 0.03 inches to about 0.20 inches.

6. The apparatus of claim 3 wherein the difference in diameter between the first circumferential pivot point and second circumferential pivot point ranges from about 0.06 inches to about 0.15 inches.

7. The apparatus of claim 3 wherein the thickness of said spring members ranges from about 0.01 inches to about 0.09 inches.

8. The apparatus of claim 3 wherein the thickness of said spring members ranges from about 0.01 inches to about 0.09 inches.

9. The apparatus of claim 3 wherein a length of said spring members ranges from about 0.04 inches to about 0.40 inches.

10. The apparatus of claim 3 wherein a width of said spring members ranges from about 0.005 inches to about 0.03 inches.

11. The apparatus of claim 3 wherein a radial degree between any two contiguous ranges from about 5 to about 40.

12. A method for engaging and retrieving one or more balls comprising:
aligning a bottom of a tubular member over a ball; and pushing down on the tubular member to pass the ball through an engaging and receiving assembly which comprises an cylindrical body having a circumferential recess integrally formed therein and wherein lodges a distinct spring assembly having a plurality of spring members.

13. The method of claim 12 wherein said passing of the ball through the engaging and receiving assembly comprises flexing in a first direction the a plurality of spring members for allowing the ball to enter into a tubular member.

14. The method of claim 13 additionally comprising flexing in a second direction the plurality of spring members.

15. The method of claim 14 wherein said flexing in said first direction is at a greater distance than flexing in the second direction.

16. The method of claim 14 wherein said flexing in the second direction retains said ball within the tubular member.

17. The apparatus of claim 1 wherein said tube member has a length ranging from about 20.00 to about 50.00 inches, and an outside diameter ranging from about 1.90 inches to about 2.10 inches; and the first circumferential pivot point and second circumferential pivot point respectively include diameters which have a difference ranging from about 0.01 inches to about 0.25 inches.

18. The method of claim 14 wherein said spring assembly includes a ring member having said plurality of spring members integrally bound thereto.

19. The apparatus of claim 2 wherein each of said spring members essentially have the same length.
